(19) United States
(12) Patent Application Publication
(10) Pub. No.: US 2012/0217926 A1
(43) Pub. Date: Aug. 30, 2012

(54) WIRELESS POWER TRANSFER

(75) Inventors: Jung Ho Yoon, Gyunggi-do (KR); Kwang Du Lee, Gyunggi-do (KR); Jeong Hoon Kim, Seoul (KR); Young Seok Yoon, Chungcheongnam-do (KR); Eung Ju Kim, Gyunggi-do (KR); Sang Hoon Hwang, Seoul (KR); Chul Gyun Park, Gyunggi-do (KR)

(73) Assignee: SAMSUNG ELECTRO-MECHANICS CO., LTD., Gyunggi-do (KR)

(21) Appl. No.: 13/168,075

(22) Filed: Jun. 24, 2011

(30) Foreign Application Priority Data
Feb. 24, 2011 (KR) 1020110016710

(51) Int. Cl. H02J 7/02

(52) U.S. Cl. 320/108

(57) ABSTRACT

Disclosed herein is a wireless power transfer system. The wireless power transfer system includes a wireless power transmitter receiving power input from the outside to generate a wireless power signal to be transmitted in wireless and transmitting the generated wireless power signal in wireless by a magnetic resonance manner using an LC serial-parallel resonance circuit; a wireless power receiver installed in a charging device to receive the wireless power signal transmitted from the wireless power transmitter by the magnetic resonance manner using the LC serial-parallel resonance circuit and output the received wireless power signal; and a charging circuit installed in the charging device to allow the power output from the wireless power receiver to charge an embedded battery, thereby making it possible to efficiently provide power in wireless.

### CROSS REFERENCE TO RELATED APPLICATION

This application claims the benefit of Korean Patent Application No. 10-2011-0016710, filed on Feb. 24, 2011, entitled “Wireless Power Transfer System,” which is hereby incorporated by reference in its entirety into this application.

### BACKGROUND OF THE INVENTION

1. Technical Field

The present invention relates to a wireless power transfer system.

2. Description of the Related Art

The existing wireless power transfer system uses the same series resonator or parallel resonator at transmitting and receiving ends or uses a combination of a transmitting end serial resonator-receiving end parallel resonator or a transmitting end parallel resonator-receiving end serial resonator. The above-mentioned scheme has a problem in that it is difficult to match between the resonator and the circuit when impedance of a circuit at the transmitting and receiving ends is changed or the wireless power transfer system is affected by external objects.

### SUMMARY OF THE INVENTION

The present invention has been made in an effort to provide a wireless power transfer system capable of easily controlling impedance matching between a resonance circuit and a transmitting and receiving circuit and coupling coefficients between resonators by using a combination of serial-parallel resonance circuits in a wireless power transfer system transmitting power in wireless.

According to a preferred embodiment of the present invention, there is provided a wireless power transfer system, including: a wireless power transmitter receiving power input from the outside to generate a wireless power signal to be transmitted in wireless and transmitting the generated wireless power signal in wireless by a magnetic resonance manner using an LC serial-parallel resonance circuit; a wireless power receiver installed in a charging device to receive the wireless power signal transmitted from the wireless power transmitter by the magnetic resonance manner using the LC serial-parallel resonance circuit and output the received wireless power signal; and a charging circuit installed in the charging device to allow the power output from the wireless power receiver to charge an embedded battery.

The wireless power transmitter may include: a frequency oscillator receiving external power to generate the wireless power signal to be transmitted; a power amplifier amplifying and outputting the wireless power signal generated in the oscillator; and a first resonance antenna including an LC serial-parallel resonance circuit and using a serial-parallel resonance frequency of the LC serial-parallel resonance circuit to transmit the wireless power signal by the magnetic resonance manner.

The first resonance antenna may include: a first variable capacitor connected to the power amplifier in series to control capacitance in order to control impedance; a second variable capacitor connected to the first variable capacitor in series to control capacitance in order to control power transfer efficiency; and a first variable inductor connected to the second variable capacitor in parallel to control inductance in order to control power transfer efficiency.

The wireless power receiver may include: a second resonance antenna including the LC serial-parallel resonance circuit and using the serial-parallel resonance frequency of the LC serial-parallel resonance circuit to receive the wireless power signal transmitted from the wireless power transmitter by the magnetic resonance manner and output the wireless power signal; and a power signal converter connected to the charging circuit and converting the wireless power signal received in the second resonance antenna into a power signal according to a power supplying manner and providing the converted power signal to the charging circuit.

The second resonance antenna may include: a third variable capacitor connected to the power signal converter in series to control capacitance in order to control impedance; a fourth variable capacitor connected to the third variable capacitor in series to control capacitance in order to control power transfer efficiency; and a second variable inductor connected to the fourth variable capacitor in parallel to control inductance in order to control the power transfer efficiency.

The wireless power receiver may further include a power switch disposed between the power signal converter and the charging circuit to block the power transmission received in the second resonance antenna.

### BRIEF DESCRIPTION OF THE DRAWINGS

FIG. 1 is a block diagram showing a wireless power transfer system transmitting and receiving power in wireless, according to a first preferred embodiment of the present invention;

FIG. 2 is an internal circuit diagram of first and second resonance antennas of FIG. 1;

FIG. 3 is a graph showing a change in impedance according to a capacitance ratio of capacitors configuring the serial-parallel resonance circuits of FIG. 1;

FIG. 4A is a diagram showing a first tuned resonance frequency f₀ and FIG. 4B shows two resonance frequencies f₁ and f₂ of mode degeneration as a result of electromagnetic coupling;

FIG. 5 is a graph showing maximally obtainable energy transfer efficiency according to a coupling coefficient k; and

FIG. 6 is a block diagram showing a wireless power transfer system transmitting and receiving power in wireless, according to a second preferred embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

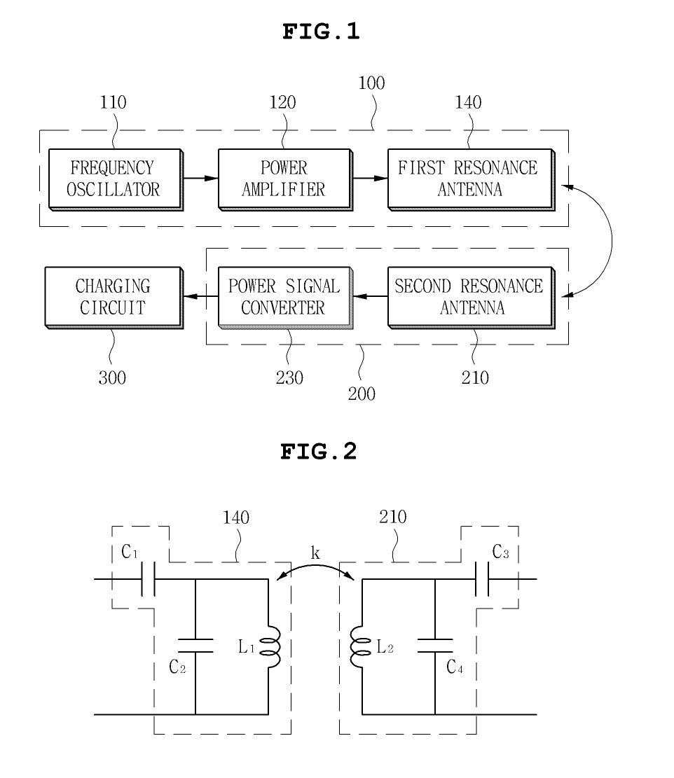

FIG. 1 is a configuration diagram showing a wireless power transfer system transmitting and receiving power in wireless, according to a first preferred embodiment of the present invention.

Referring to FIG. 1, the wireless power transfer system according to the first preferred embodiment of the present invention is largely configured to include a wireless power transmitter 100, a wireless power receiver 200, and a charging circuit 300.

The wireless power transmitter 100 is configured to include a frequency oscillator 110, a power amplifier 120, and a first resonance antenna 140.

The wireless power receiver 200 is configured to include a second resonance antenna 210 and a power signal converter 230.

The wireless power transmission between the wireless power transmitter 100 and the wireless power receiver 200 is performed by a magnetic resonance manner.

That is, the wireless power transmitted from the wireless power transmitter 100 by the magnetic resonance manner is received in the wireless power receiver 200 by the magnetic resonance manner and the received wireless power is supplied to the charging circuit 300 connected to the wireless power receiver 200.

Schematically describing the wireless power transmission process due to the magnetic resonance manner between the wireless power transmitter 100 and the wireless power receiver 200, the wireless power signal is first generated in the wireless power transmitter 100 and the generated wireless power signal is converted and transmitted into magnetic energy due to the LC serial-parallel resonance of the LC serial-parallel circuit of the first resonance antenna 140.

Accordingly, the second resonance antenna 210 configured to include the LC serial-parallel circuit of the wireless power receiver 200 receives the magnetic energy transmitted from the first resonance antenna 140 by the magnetic coupling and converts and outputs the received magnetic energy into the wireless power signal.

In this case, the tuning is performed by matching the LC serial-parallel resonance frequency of the first resonance antenna 140 with the LC serial-parallel resonance frequency of the second resonance antenna 210, thereby making it possible to maximize the magnetic coupling.

As described above, since the transfer efficiency is rapidly increased when the serial-parallel resonance frequencies of the first and second resonance antennas 140 and 210 are the same, the frequency calibration for the serial-parallel resonance frequencies of the first resonance antenna 140 and the second resonance antenna 210 is required to match the serial-parallel resonance frequencies between the first resonance antenna 140 and the second resonance antenna 210.

Meanwhile, the charging circuit 300 is installed in the charging device to be used to charge a battery embedded in the charging device with the converted wireless power signal output from the wireless power receiver 200.

From now, each component and operation of the wireless power transmitter 100 and the wireless power receiver 200 in the wireless power transfer system according to the first preferred embodiment of the present invention will be described in more detail.

First, the frequency oscillator 110 converts the external power into the wireless power signal. In this case, the wireless power signal is an alternating signal and the alternating signal input from the outside may have an alternating signal type that is not suitable to transmit the wireless power, such that the frequency oscillator 110 converts and outputs the external power into the alternating signal suitable to transmit the external power in wireless.

The power amplifier 120 amplifies wireless power signal output from the frequency oscillator 110 to the predetermined power in order to increase the efficiency of the wireless power transmission.

Next, the first resonance antenna 140 includes the LC serial-parallel circuit and when the wireless power signal is input, the LC serial-parallel circuit converts and transmits the received wireless power signal into the magnetic energy due to the LC serial-parallel resonance.

Meanwhile, the second resonance antenna 210 includes the LC serial-parallel circuit and receives the magnetic energy transmitted from the first resonance antenna 140 due to the LC serial-parallel resonance by the LC serial-parallel circuit. And the magnetic energy forms a closed loop between the first resonance antenna 140 and the second resonance antenna 210 by the magnetic resonance manner.

Then, the second resonance antenna 210 supplies the wireless power signal received from the first resonance antenna 140 of the wireless power transmitter 100 to the power signal converter 230.

Next, the power signal converter 230 converts and outputs the wireless power signal into the proper DC signal in order to supply power to the connected charging circuit 300.

FIG. 2 is a detailed block diagram shown a configuration of the first and second resonance antenna shown in FIG. 1.

Referring to FIG. 2, the first resonance antenna 140 shown in FIG. 1 is configured to include a first variable capacitor C1 connected to the power amplifier 120 in series and a second variable capacitor C2 and a first inductor L1 connected to the first variable capacitor C1 in series and configuring the LC parallel circuit.

Further, the second resonance antenna 210 shown in FIG. 1 is configured to include a third variable capacitor C3 connected to the power signal converter 230 in series and a fourth variable capacitor C4 and a second inductor L2 connected to a third variable capacitor C3 in series and configuring the LC parallel circuit.

In the above-mentioned configuration, the first variable capacitor C1 controls capacitance to perform the impedance matching.

The first variable capacitor C1 provides the impedance matching between the load impedance of the power amplifier 120 and the LC parallel circuit of the first resonance antenna 140 in order to transmit the wireless power signal at optimal transfer efficiency.

In this case, the load impedance for optimally driving the power amplifier 120 requires several ohms [Ω], while the impedance of the LC parallel circuit of the first resonance antenna 140 for making a Q-factor large is very large as several hundred ohms [Ω] or more.

Therefore, the transfer efficiency is greatly reduced by the impedance mis-matching between the power amplifier 120 and the first resonance antenna 140, such that the impedance matching is required.

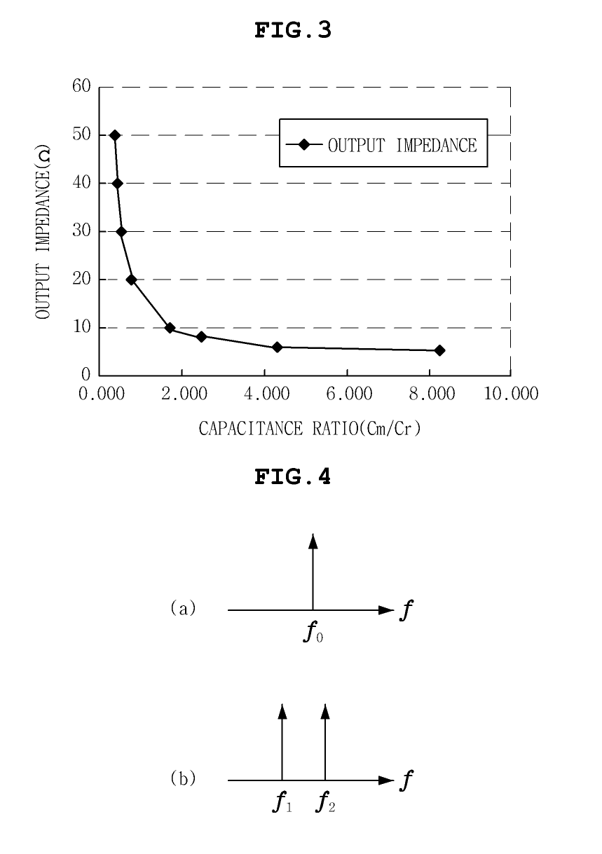

As shown in FIG. 3, the impedance of the first resonance antenna 140 is controlled by controlling a ratio Cm/Cr of capacitance of the first variable capacitor C1 and the second variable capacitor C2 while constantly maintaining a sum of capacitance Cm of the first variable capacitor C1 and capacitance Cr of the second variable capacitor C2.

Further, the first resonance antenna 140 converts and transmits the wireless power signal received by the LC serial-parallel resonance of the first variable inductor L1 and the first and second variable capacitors C1 and C2 into the magnetic energy.

Meanwhile, the third variable capacitor C3 performs the impedance matching by controlling its capacitance.

The third variable capacitor C3 provides the impedance matching between the load impedance of the power signal converter 230 and the LC parallel circuit of the second resonance antenna 210 in order to receive the wireless power signal at optimal transfer efficiency.

In this case, the load impedance for driving the power signal converter 230 requires several ohms [Ω], while the impedance of the LC parallel circuit of the second resonance antenna 210 for making a Q-factor large is very large as several hundred ohms [Ω].

Therefore, the transfer efficiency is greatly reduced by the impedance mis-matching between the power signal converter 230 and the second resonance antenna 210, such that the impedance matching is required.

The impedance of the second resonance antenna 210 is controlled by controlling the ratio Cm/Cr of the capacitance of the third variable capacitor C3 and the fourth variable capacitor C4 while constantly maintaining the sum of capacitance (the same value Cm as the capacitance of the first variable capacitor) of the third variable capacitor C3 and the capacitance (the same value Cr as the capacitance of the second variable capacitor) of the fourth variable capacitor C4.

Further, the second resonance antenna 210 receives the magnetic energy and converts and outputs the received magnetic energy into the wireless power signal by the LC serial-parallel resonance of the second variable inductor L2 and the third and fourth variable capacitors C3 and C4 when it receives the magnetic energy.

The operations of the first resonance antenna 140 and the second resonance antenna 210 that are operated as described above will be described in more detail below. The LC serial-parallel circuit including the first variable capacitor C1 and the first variable inductor L1 and the second variable capacitor C2 connected thereto that configures the first resonance antenna 140 is electromagnetically coupled with the LC serial-parallel circuit including the third variable capacitor C3 and the second variable inductor L2 and the fourth variable capacitor C4 connected thereto in parallel that configure the second resonance antenna 210.

Although two LC serial-parallel resonance circuits configuring the first resonance antenna 140 and the second resonance antenna 210 are physically degenerated from each other in wireless, the electromagnetic coupling therebetween interact with each other to separate the frequency of the parallel resonance circuit from the first tuned resonance frequency fₒ as shown In FIG. 4A.

In the state where the LC serial-parallel resonance circuits are far away from each other so as not to have an effect on each other, the first resonance frequency is determined by values of elements configuring the first resonance antenna 140 and the second resonance antenna 210.

Providing that the capacitances of the first variable capacitor C1 and the third variable capacitor C3 are the same (the same as Cm), the capacitances of the second variable capacitor C2 and the fourth variable capacitor C4 are the same (the same as Cr), and the inductances of the first variable inductor L1 and the second variable inductor L2 are the same (the same as Lr), the first resonance frequency f₀ is determined as the following Equation 1.

$${f}_{0} = \frac{1}{2 π \sqrt{{L}_{r} ( {C}_{r} + {C}_{m} )}} \qquad [ Equation 1 ]$$

Meanwhile, providing that the LC serial-parallel resonance circuits that are separated from each other approaches to each other, mode degeneration occurs in the first tuned resonance frequency as shown in FIG. 4B.

Two frequencies f₁ and f₂ generated by the mode degeneration are shown as frequencies above and below the center of the resonance frequency and the distance between two frequencies is determined according to how strong the electromagnetic coupling between two serial-parallel resonance circuits is.

In the case of configuring the system for transmitting power between the two resonance circuits in wireless, the coupling coefficient k that is an important factor is determined by the following Equation 2 according to the distance between the two mode frequencies.

$$k = \frac{{f}_{2}^{2} - {f}_{1}^{2}}{{f}_{2}^{2} + {f}_{1}^{2}} \qquad [ Equation 2 ]$$

The electromagnetic coupling coefficient k is a measure indicating how frequently the electromagnetic energy exchange between the two resonance circuits is performed and is increased as the distance between the two resonance circuits is short.

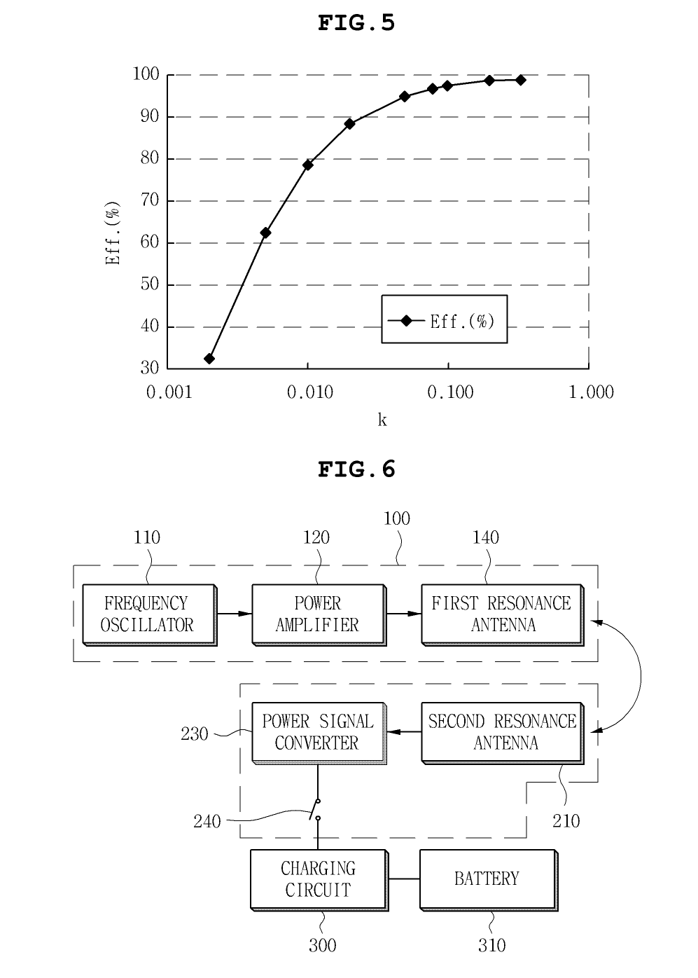

The coupling coefficient between the two serial-parallel resonance circuits includes capacitive coupling due to electric field and inductive coupling due to magnetic field and as shown in FIG. 5, may determine maximally obtainable energy transfer efficiency that can be obtained from the two serial-parallel resonance circuits.

FIG. 6 is a configuration diagram of a wireless power transfer system according to a preferred second embodiment of the present invention.

As shown in FIG. 6, the wireless power transfer system according to the preferred second embodiment of the present invention is configured to include the wireless power transmitter 100, the wireless power receiver 200, and the charging circuit 300, wherein the first wireless power transmitter 100 is configured to include the frequency oscillator 110, the power amplifier 120, and the first resonance antenna 140 and the wireless power receiver 200 is configured to include the second resonance antenna 210, the power signal converter 230, and the power switch 240, such that the wireless power receiver 200 further includes a power switch 240 unlike the first preferred embodiment of the present invention.

In the wireless power transfer system according to the second preferred embodiment of the present invention having the above-mentioned configuration, the same components as the first preferred embodiment performs the same operation as the first preferred embodiment and therefore, the difference therebetween will be described below.

First, the power switch 240 ends the coupling with the power signal converter 230 of the wireless power receiver 200 when a battery 310 connected to the charging circuit 300 of the wireless power receiver 200 does not require power any more (for example, when the charging of the battery 310 is completed). On the other hand, when the battery 310 connected to the charging circuit 300 of the wireless power receiver 200 requires power (for example, when the charging of the battery 310 is required), the switching is performed to start the coupling with the power signal converter 230 of the wireless power receiver 200.

The charging circuit 300 receives DC current transmitted from the power signal converter 230 to charge the battery 310.

Meanwhile, the battery 310 that is a small-capacity battery is charged by being supplied with power supplied from the charging circuit 300 and supplies power to a device operation circuit (not shown), if necessary.

As set forth above, the preferred embodiment of the present invention can implement a system capable of charging a device without having the power line connecting in a wired line using the wireless power transmission technology.

Further, the preferred embodiment of the present invention can provide a system of supplying power necessary to operate the device of the user by receiving the wireless power from the power transmission device in real time.

In addition, the exemplary embodiment of the present invention can make the transfer efficiency excellent by transmitting power using the combination of the LC serial-parallel resonance circuits and the electromagnetic coupling therebetween.

Moreover, the preferred embodiment of the present invention can facilitate the impedance matching between the transmitting and receiving circuits by controlling the component ratio between the LC serial-parallel resonance circuits and increase the transfer efficiency accordingly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A wireless power transfer system, comprising:
a wireless power transmitter receiving power input from the outside to generate a wireless power signal to be transmitted in wireless and transmitting the generated wireless power signal in wireless by a magnetic resonance manner using an LC serial-parallel resonance circuit;
a wireless power receiver installed in a charging device to receive the wireless power signal transmitted from the wireless power transmitter by the magnetic resonance manner using the LC serial-parallel resonance circuit and output the received wireless power signal; and
a charging circuit installed in the charging device to allow the power output from the wireless power receiver to charge an embedded battery.

2. The wireless power transfer system as set forth in claim 1, wherein the wireless power transmitter includes:
a frequency oscillator receiving external power to generate the wireless power signal to be transmitted;
a power amplifier amplifying and outputting the wireless power signal generated in the oscillator; and
a first resonance antenna including an LC serial-parallel resonance circuit and using a serial-parallel resonance frequency of the LC serial-parallel resonance circuit to transmit the wireless power signal by the magnetic resonance manner.

3. The wireless power transfer system as set forth in claim 2, wherein the first resonance antenna includes:
a first variable capacitor connected to the power amplifier in series to control capacitance in order to control impedance;
a second variable capacitor connected to the first variable capacitor in series to control capacitance in order to control power transfer efficiency; and
a first variable inductor connected to the second variable capacitor in parallel to control inductance in order to control power transfer efficiency.

4. The wireless power transfer system as set forth in claim 1, wherein the wireless power receiver includes:
a second resonance antenna including the LC serial-parallel resonance circuit and using the serial-parallel resonance frequency of the LC serial-parallel resonance circuit to receive the wireless power signal transmitted from the wireless power transmitter by the magnetic resonance manner and output the wireless power signal; and
a power signal converter connected to the charging circuit and converting the wireless power signal received in the second resonance antenna into a power signal according to a power supplying manner and providing the converted power signal to the charging circuit.

5. The wireless power transfer system as set forth in claim 4, wherein the second resonance antenna includes:
a third variable capacitor connected to the power signal converter in series to control capacitance in order to control impedance;
a fourth variable capacitor connected to the third variable capacitor in series to control capacitance in order to control power transfer efficiency; and
a second variable inductor connected to the fourth variable capacitor in parallel to control inductance in order to control the power transfer efficiency.

6. The wireless power transfer system as set forth in claim 4, wherein the wireless power receiver further includes a power switch disposed between the power signal converter and the charging circuit to block the power transmission received in the second resonance antenna.
